(19) United States
(12) Patent Application Publication
(10) Pub. No.: US 2009/0175464 A1
(43) Pub. Date: Jul. 9, 2009

(54) Headset For Voice Activation/Confirmation Enabled Surgical Console

(76) Inventors: Bryan M. Somen, Santa Ana, CA (US); Christopher Horvath, Irvine, CA (US)

Correspondence Address: ALCON, IP LEGAL, TB4-8, 6201 SOUTH FREEWAY, FORT WORTH, TX, 76134, US

(21) Appl. No.: 11/970,794

(22) Filed: Jan. 8, 2008

(51) Int. Cl. H04R 1/10; G10L 15/00

(52) U.S. Cl. 381/74; 704/246; 704/E15.001; 606/1

(57) ABSTRACT

A surgical system includes a surgical console, a headset, and a headset interface. The surgical console operates a voice confirmation system. The headset interface provides a communications link between the headset and the surgical console.

### BACKGROUND OF THE INVENTION

The present invention relates to a system with a surgical console and a headset and more particularly to a headset for use with an ophthalmic surgical console.

Anatomically, the eye is divided into two distinct parts—the anterior segment and the posterior segment. The anterior segment extends from the outermost layer of the cornea (the corneal epithelium) to the posterior of the lens capsule. The posterior segment includes the portion of the eye behind the lens capsule. The posterior segment extends from the anterior hyaloid face to the retina, with which the posterior hyaloid face of the vitreous body is in direct contact. Ocular surgery involves making an incision to gain entry to the eye. Various surgical procedures are commonly performed on the anterior and posterior segments of the eye. In the anterior segment, cataract surgery is most common.

The eye's natural lens is composed of an outer lens capsule enclosing a lens cortex. Since the human eye functions to provide vision by transmitting light through a clear outer portion called the cornea, and focusing the image by way of a clear crystalline lens onto a retina, the quality of the focused image depends on many factors including the transparency of the lens. When age or disease causes the lens to become less transparent, vision deteriorates because of the diminished light which can be transmitted to the retina. This deficiency in the lens of the eye is medically known as a cataract. An accepted treatment for this condition is cataract surgery which involves the removal and replacement of the lens cortex by an artificial intraocular lens (IOL).

In the United States, the majority of cataractous lenses are removed by a surgical technique called phacoemulsification. During this procedure, an incision of a few millimeters in size is made in the cornea or sclera. By way of the incision, a thin phacoemulsification cutting tip is inserted into the diseased lens and vibrated ultrasonically. The vibrating cutting tip liquefies or emulsifies the lens cortex material so that it may be aspirated out of the eye. The diseased lens material, once removed, is replaced by an IOL.

The IOL is injected into the eye through the same small incision used to remove the diseased lens cellular material. The IOL is placed in an IOL injector in a folded state to avoid enlarging the incision. The tip of the IOL injector is inserted into the incision, and the lens is delivered into the lens capsular bag.

Since the typical cataract surgery takes less than twenty minutes, the surgery may be performed while the patient is under a local anesthetic. As such, the patient is awake and alert during surgery. Most patients naturally feel anxious about cataract surgery. Being awake during surgery often heightens this anxiety. With the advent of voice activation and voice confirmation on surgical consoles for cataract surgery, the surgeon and the surgical console may voice commands and responses. Some of these commands and responses may be upsetting to the patient or cause further anxiety. Further, since cataract surgery is performed around the world, it is performed in some noisy environments. Clinics in developing countries are often noisy. It would be desirable to have a system that can be used with a surgical console that has voice activation and voice confirmation that addresses these concerns.

### SUMMARY OF THE INVENTION

In one embodiment consistent with the principles of the present invention, the present invention is a surgical system that includes a surgical console, a headset, and a headset interface. The surgical console operates a voice confirmation system. The headset interface provides a communications link between the headset and the surgical console.

It is to be understood that both the foregoing general description and the following detailed description are exemplary and explanatory only and are intended to provide further explanation of the invention as claimed. The following description, as well as the practice of the invention, set forth and suggest additional advantages and purposes of the invention.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a view of a headset and surgical console system according to an embodiment of the present invention.

FIG. 2 a view of a headset and surgical console system according to an embodiment of the present invention.

### DETAILED DESCRIPTION OF THE PREFERRED EMBODIMENTS

Reference is now made in detail to the exemplary embodiments of the invention, examples of which are illustrated in the accompanying drawings. Wherever possible, the same reference numbers are used throughout the drawings to refer to the same or like parts.

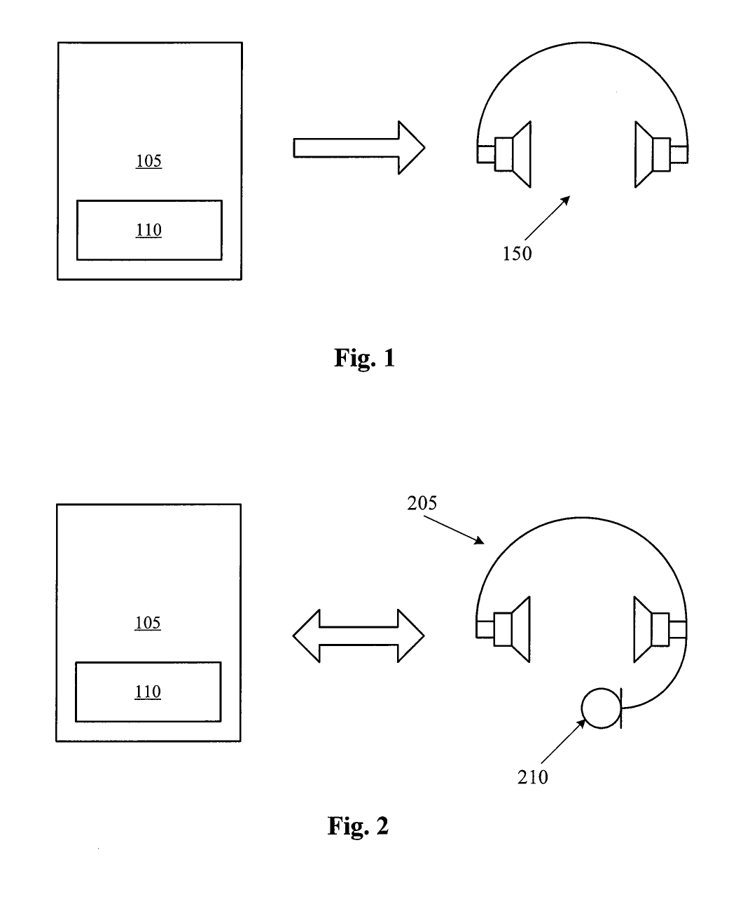

FIG. 1 is a view of a headset and surgical console system according to the principles of the present invention. In FIG. 1, the system includes a surgical console 105 with a headset interface 110 and a headset 150. Surgical console 105 is any console that is typically used to perform surgery while the patient is awake. For example, surgical console 105 may be a cataract surgical console that is specifically designed for cataract surgery.

Headset interface 110 provides an interface between surgical console 105 and headset 150. While shown as a part of surgical console 105, headset interface 110 may also be separate from surgical console 105. Headset interface 105 typically contains circuitry adapted to transmit signals to and/or receive signals from headset 150. As such, headset interface 110 can be a receiver or a transceiver. In some embodiments, headset interface 110 is designed to send and/or receive signals via a hard wired connection, such as an electrical conductor. In other embodiments, headset interface 110 is designed to send and/or receive signals via a wireless connection. Examples of such wireless connections include, but are not limited to, Bluetooth, Wi-fi, firewire, various 802.11 protocols, and the like. Other wireless connections may include typical cellular or other wireless radio protocols

In the embodiment of FIG. 1, headset 150 is a typical wired or wireless headset. If wired, headset 150 communicates with headset interface 110 via a hard wired connection. If wireless, headset 150 communicates with headset interface 110 via a wireless connection. As such, headset 150 has a transceiver or other similar device to communicate with headset interface 110. Headset 150 may have one or two speakers that reproduce sound, such as voice confirmation words or tones. Headset 150 can be worn by a surgeon so that only the surgeon, and not the patient, can hear such sounds. In addition, in noisy environments, a surgeon wearing headset 150 can more easily hear the voice confirmation commands. Headset 150, therefore, provides the surgeon with optimal voice feedback from console 105 while masking these console responses from the patient. This not only allows the surgeon to better hear the responses, but also prevents the patient from hearing them, thus reducing patient stress in the unfamiliar environment of the operating room.

Headset 150 may be configured in any appropriate manner. For example, headset 150 may have a single small speaker that fits in the surgeon's ear (much like an ear bud for a portable music device). A larger speaker that can be worn comfortably on the outside of the surgeon's ear may also be employed (much like a Bluetooth headset for a cellular phone).

FIG. 2 is a view of a headset and surgical console system according to the principles of the present invention. In the embodiment of FIG. 2, headset 150 includes a microphone 210. Microphone 210 allows a surgeon to send voice commands to surgical console 105 via headset interface 110. In noisy environments, providing a microphone in close proximity to the surgeon's head enables better voice pick up. In a typical voice activation system, the microphone and speakers are located on a surgical console which may be several feet away from the surgeon. Providing a microphone 210 and headset 150 close to the surgeon provides for better system performance. In all other respects, the system of FIG. 2 is the same as that of FIG. 1.

Headset 150 and microphone 210 of FIG. 2 can be in any suitable configuration. For example, headset 150 may have a single speaker that is integrated into a slim profile device with microphone 210 (much like a Bluetooth headset for a cellular phone).

From the above, it may be appreciated that the present invention provides an improved surgical system. Enabling a surgical console with a headset interface and providing a headset for a surgeon's use provides better operation of voice activation/voice confirmation while reducing the stress a patient experiences during surgery. The present invention is illustrated herein by example, and various modifications may be made by a person of ordinary skill in the art.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A surgical system comprising:
a surgical console operating a voice confirmation system;
a headset;
a headset interface that provides a communications link between the headset and the surgical console.

2. The system of claim 1 wherein the headset further comprises:
at least one speaker.

3. The system of claim 2 wherein the headset further comprises:
a microphone.

4. The system of claim 1 wherein the surgical console further operates a voice activation system.

5. The system of claim 1 further comprising:
an electrical conductor connecting the headset to the headset interface.

6. The system of claim 1 wherein the communications link is enabled by a wireless protocol.

7. The system of claim 2 wherein the headset further comprises:
a receiver for receiving signals from the headset interface.

8. The system of claim 3 wherein the headset further comprises:
a transceiver for communicating with the headset interface.

9. The system of claim 7 wherein the headset interface further comprises:
a transmitter for transmitting signals to the headset.

10. The system of claim 8 wherein the headset interface further comprises:
a transceiver for communicating with the headset.
